(19) United States
(12) Patent Application Publication
(10) Pub. No.: US 2006/0188203 A1
(43) Pub. Date: Aug. 24, 2006

(54) Optical fiber protective tube

(75) Inventors: Hidetomi Mitsuishi, Gotemba-shi (JP); Mitsuyoshi Jinguuji, Gotemba-shi (JP); Hiroshi Kodama, Gotemba-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/348,262

(22) Filed: Feb. 7, 2006

(30) Foreign Application Priority Data
Feb. 16, 2005 (JP) P2005-038673

(51) Int. Cl. G02B 6/44

(52) U.S. Cl. 385/100

(57) ABSTRACT

An optical fiber protective tube is designed for the passage of an optical fiber element (having a primary coating of an ultraviolet-curable (UV-curable) resin or the like formed on an outer periphery of a bare fiber) therethrough so as to protect the optical fiber element. The optical fiber protective tube includes a resin tube made of polyether ether ketone (PEEK), and a layer of reinforcing fiber and a resin covering which are provided on an outer periphery of the resin tube.

### BACKGROUND OF THE INVENTION

1. Field of the Invention

This invention relates to an optical fiber protective tube for protecting an optical fiber element.

2. Related Art

An optical fiber element has a primary coating (made of an ultraviolet-curable (UV-curable) resin or the like) formed on an outer periphery of a bare fiber. When the surface of the optical fiber element is damaged, its mechanical characteristics are lowered, so that its reliability is adversely affected, and therefore it is known to protect the optical fiber element by the use of an optical fiber protective tube (also called a reinforcing cord), in which case the optical fiber element is passed through the optical fiber protective tube having an inner diameter larger than an outer diameter of the optical fiber element (see, for example, JP-A-2000-19364).

The following problem is encountered with the conventional optical fiber protective tube when carrying out an operation for passing the optical fiber element through the protective tube. Namely, when the optical fiber element is passed through the protective tube, static electricity develops because of the relation between the material of the primary coating and the material (for example, nylon, polyester elastomer or the like) of the optical fiber protective tube, and this leads to a problem that the optical fiber element sticks to the inner surface of the protective tube. In the conventional operation, the optical fiber element must be passed through the protective tube while applying an anti-static treatment, and therefore there are encountered problems that the efficiency of the operation is low and that much time and labor are required for the operation, so that the cost inevitably increases.

And besides, the expansion and contraction of the conventional optical fiber protective tube are relatively large because of its material, and the protective tube has a problem that a loss in the optical fiber due to contraction increases at a low temperature. Particularly at a low temperature of below −30° C., the increased loss in the optical fiber becomes conspicuous, thus inviting a problem that the protective tube is not suited for use in cold districts.

### SUMMARY OF THE INVENTION

This invention has been made in view of the above circumstances, and an object of the invention is to provide an optical fiber protective tube which enhances the efficiency of an operation for passing an optical fiber element through the protective tube, and also enhances optical characteristics at a low temperature.

(1) The above problems have been solved by an optical fiber protective tube of the invention for protecting an optical fiber element, wherein the protective tube includes a resin tube for passing an optical fiber element therethrough; characterized in that the resin tube is made of polyether ether ketone.

In the invention having the above feature, the resin tube, forming the optical fiber protective tube, is molded of polyether ether ketone (PEEK) belonging to “super engineering plastic”. When the optical fiber element (comprising a bare optical fiber, and a UV-curable resin coated on the bare optical fiber) is to be passed through the resin tube made of polyether ether ketone, it is not necessary to take any countermeasure against the sticking of the optical fiber element due to static electricity, which countermeasure has heretofore been required for the conventional optical fiber protective tube. The resin tube, made of polyether ether ketone, enhances the efficiency of the operation, so that the time and labor, required for the operation, can be reduced. And besides, the expansion of the resin tube, made of polyether ether ketone, is small at a low temperature, and therefore the increase of a loss in the fiber can be kept to a low level.

(2) The optical fiber protective tube of the invention may be further characterized in that a layer of reinforcing fiber and a resin covering are provided on an outer periphery of said resin tube.

In the invention having the above feature, the optical fiber protective tube comprises the resin tube, made of polyether ether ketone, and the layer of reinforcing fiber and the resin covering which are provided on the outer periphery of the resin tube. The resin tube is protected by the reinforcing fiber layer and the resin covering provided on the outer periphery of the resin tube, and with this construction the optical fiber protective tube secures sufficient mechanical characteristics.

In the invention, there is achieved an advantage that the efficiency of the operation for passing the optical fiber element through the optical fiber protective tube, as well as the optical characteristics at a low temperature, can be enhanced as compared with the conventional construction. In the invention, there is achieved an advantage that the better form of optical fiber protective tube can be provided.

### BRIEF DESCRIPTION OF THE DRAWINGS

FIG. 1 is a view of one preferred embodiment of an optical fiber protective tube of the present invention.

FIG. 2 is a graph showing results of a test for the optical fiber protective tube of the invention.

FIG. 3 is a plan view of a fan-out optical cord.

### DETAILED DESCRIPTION OF THE PREFERRED EMBODIMENTS

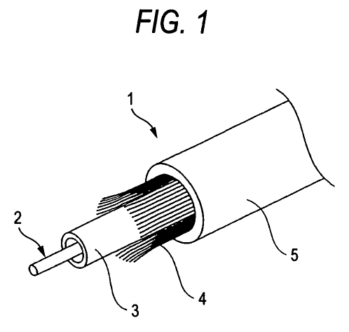

The present invention will now be described with reference to the drawings. FIG. 1 is a view of one preferred embodiment of an optical fiber protective tube of the invention, showing its construction.

In FIG. 1, the optical fiber protective tube 1 is designed for the passage of an optical fiber element 2 (having a primary coating (made of an ultraviolet-curable (UV-curable) resin or the like) formed on an outer periphery of a bare fiber) therethrough so as to protect the optical fiber element. The optical fiber protective tube 1 comprises a resin tube 3 made of polyether ether ketone (PEEK), and a layer of reinforcing fiber 4 (made for example of poly-aramid) and a resin covering (or sheath) 5 (made for example of polyvinyl chloride) which are provided on an outer periphery of the resin tube 3.

Here, the resin tube 3 is made of polyether ether ketone in order to obviate the need for taking countermeasures against the sticking of the optical fiber element 2 due to static electricity. Another purpose is to keep the increase of a loss of the optical fiber element 2 due to contraction at a low temperature to a low level. Here, polyether ether ketone (PEEK) will be briefly described. It is known that PEEK is a material belonging to “super engineering plastic”, and this material has excellent wear resistance and chemical resistance. And besides, polyether ether ketone (PEEK) is a flame retardant material, and therefore is suitable as a material for forming the optical fiber protective tube 1.

A test for the optical fiber protective tube 1 of the invention, as well as results of this test, will be described. Here, there is adopted a test method in which a sample (having a length of 3 m) is prepared by passing the optical fiber element 2 through the optical fiber protective tube 1, and this sample is put into a test vessel, and in this condition a temperature is changed in the range of between −40° C. and 75° C. while passing an optical signal through the optical fiber element 2, and in this condition a variation in optical power is monitored.

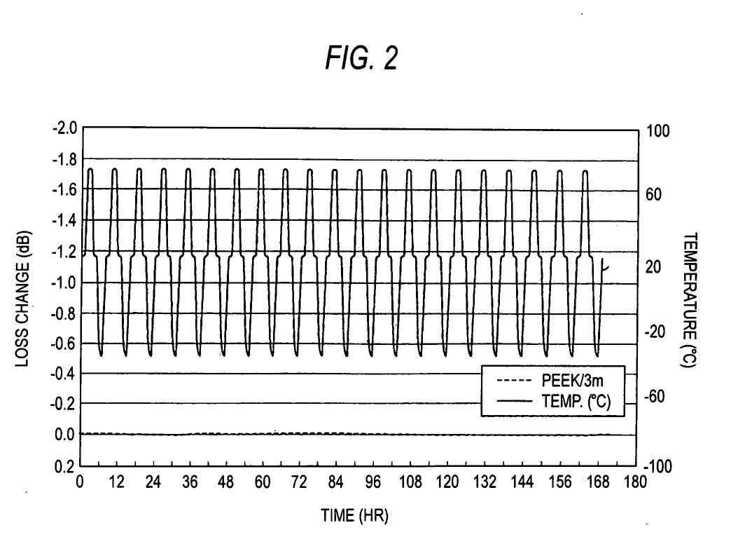

FIG. 2 is a graph showing the results of the test for the optical fiber protective tube 1 of the invention. In the above test, the optical fiber projective tube 1 has stable optical characteristics even at a temperature of −40° C. (At −40° C., only less than 0.1 dB increases relative to a reference value.) as shown in FIG. 2.

When the resin tube is made, for example, of nylon (although not particularly shown in the drawings), results of a test (similar to the above test) indicate that a loss abruptly increases when the temperature goes below about −30° C. The reason for this is that when the resin tube is formed by the use of an ordinary resin such as nylon, the optical fiber element within the resin tube is slackened due to contraction developing at a low temperature (The amount of slack of the resin tube made of such an ordinary resin exceeds a predetermined value at a low temperature, and the increase of the loss due to bending is recognized.).

As described above with reference to FIGS. 1 and 2, the optical fiber protective tube 1 of the invention includes the resin tube 3 made of polyether ether ketone (PEEK), and therefore there is achieved an advantage that the optical fiber protective tube 1 has the stable optical characteristics even at a low temperature and particularly at about −40° C.

And besides, in the optical fiber protective tube 1 of the invention, the resin tube 3 is made of polyether ether ketone (PEEK), and therefore when the optical fiber element 2 is to be passed through the protective tube 1, it is not necessary to take any countermeasure against the sticking of the optical fiber element 2 due to static electricity. As a result, there are achieved advantages that the efficiency of the operation is enhanced and that the time and labor, required for the operation, can be reduced.

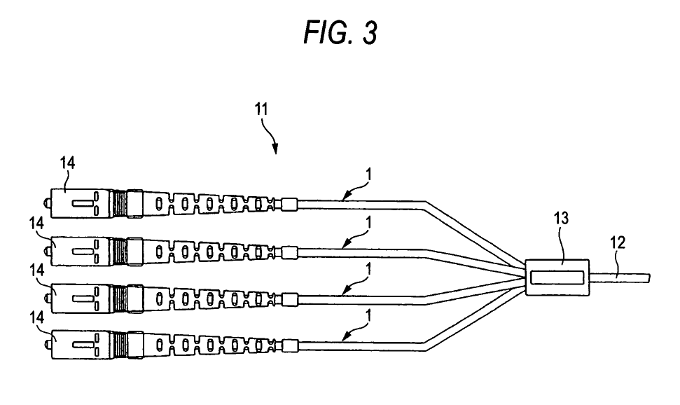

Next, description will be made of an example in which the advantageous effects of the optical fiber protective tube 1 of the invention are clearly recognized. FIG. 3 is a plan view showing a fan-out optical cord given as one example.

In FIG. 3, reference numeral 11 denotes the fan-out optical cord. The fan-out optical cord 11 is used for leading an optical fiber from a closure (existing at an intermediate portion of an overhead optical cable of an optical communication network) into a user's house. Reference numeral 12 denotes an optical fiber tape, reference numeral 13 denotes a branch portion, and reference numeral 14 denotes an optical connector. Optical fiber elements, branching from the optical fiber tape 1 via the branch portion 13, are protected respectively by optical fiber protective tubes 1 of the invention, and are connected respectively to the optical connectors 14.

In the present invention, various modifications can be made without departing from the subject matter of the invention.

What is claimed is:

1. An optical fiber protective tube for protecting an optical fiber element, comprising:
a resin tube for passing an optical fiber element therethrough; characterized in that:
said resin tube is made of polyether ether ketone.

2. An optical fiber protective tube according to claim 1, wherein a layer of reinforcing fiber and a resin covering are provided on an outer periphery of said resin tube.
